(19) United States
(12) Patent Application Publication
(10) Pub. No.: US 2024/0171912 A1
(43) Pub. Date: May 23, 2024

(54) DIAPHRAGM, DIAPHRAGM WITH EXCITER, AND VEHICULAR DIAPHRAGM

(71) Applicant: AGC Inc., Tokyo (JP)

(72) Inventors: Kento SAKURAI, Tokyo (JP); Jun AKIYAMA, Tokyo (JP)

(73) Assignee: AGC Inc., Tokyo (JP)

(21) Appl. No.: 18/425,172

(22) Filed: Jan. 29, 2024

Related U.S. Application Data
(63) Continuation of application No. PCT/JP2022/028770, filed on Jul. 26, 2022.

(30) Foreign Application Priority Data
Jul. 30, 2021 (JP) 2021-125678

(51) Int. Cl. H04R 7/04; B60R 11/02

(52) U.S. Cl. CPC H04R 7/04; B60R 11/02

(57) ABSTRACT

A diaphragm includes: a plate-shaped body having a pair of main surfaces facing each other; and a connection portion connected to one of the main surfaces of the plate-shaped body, in which the connection portion has a function of transmitting vibration of an exciter to the plate-shaped body from a side opposite to a side where the plate-shaped body is located, the connection portion includes a spacer and an adhesive portion having a lower hardness than the spacer, and a thickness of the connection portion is defined by a thickness of the spacer.

### CROSS-REFERENCE TO RELATED APPLICATIONS

This is a bypass continuation of International Patent Application No. PCT/JP2022/028770, filed on Jul. 26, 2022, which claims priority to Japanese Patent Application No. 2021-125678, filed on Jul. 30, 2021. The contents of these applications are hereby incorporated by reference in their entireties.

### TECHNICAL FIELD

The present invention relates to a diaphragm, a diaphragm with an exciter, and a vehicular diaphragm used for a vehicle.

### BACKGROUND ART

In recent years, a technique of vibrating various plate-shaped members to function as speakers has been studied. Examples of the member that can be a speaker include an electronic device member, a vehicular window member, and an interior member of a transport machine such as a vehicle.

Patent Literature 1 discloses an exciter including a magnetostrictive element and a holder that includes the magnetostrictive element and in which a thread groove is provided in at least a part of an outer periphery. Accordingly, it is possible to provide an exciter that is easily attached and can generate a sound having a large volume.

Patent Literature 2 discloses a speaker device including an acoustic diaphragm, a vibration transmission member provided so as to be in contact with the acoustic diaphragm by a predetermined length, and an actuator that applies vibration according to an audio signal to be reproduced. Accordingly, a transmission efficiency of vibration to the acoustic diaphragm can be improved, and a wider frequency band can be covered.

As described above, a structure is known in which vibration of an exciter (actuator) to be electrically vibrated is transmitted to a diaphragm such as a glass plate.

Patent Literature 3 discloses a speaker device including a diaphragm, an exciter, and a vibration transmission portion, in which a loss factor of the diaphragm and a specific modulus of the vibration transmission portion are in a certain range. More specifically, a configuration is disclosed in which the exciter is attached to the diaphragm via the vibration transmission portion, and a rod holding member is adhered and fixed to a glass substrate surface. Accordingly, an excellent designability can be exhibited without impairing designability of the diaphragm while maintaining an acoustic performance.
Patent Literature 1: JP2013-198082A
Patent Literature 2: JP2010-263512A
Patent Literature 3: WO2019/172076

### SUMMARY OF INVENTION

However, when the exciter and the diaphragm are fixed to each other using an adhesive in order to transmit the vibration generated by the exciter to the diaphragm such as a glass, the thickness of the adhesive varies. As a result, the performance of the diaphragm may vary, and an individual difference of the performance of the diaphragm to which the exciter is attached may vary. The above phenomenon is particularly remarkable when the thickness of the adhesive is, for example, 1 mm or more.

An object of the present invention to provide a diaphragm, a diaphragm with an exciter, and a vehicular diaphragm that control the thickness of a connection portion of the diaphragm for connection to the exciter and have small variations in performance.

As a result of intensive studies, the present inventors have found that the above problems can be solved by including a spacer in a connection portion in order to define the thickness of the connection portion, and have completed the present invention.

That is, the present invention relates to the following [1] to [26].

[1] A diaphragm including:
a plate-shaped body having a pair of main surfaces facing each other; and
a connection portion connected to one of the main surfaces of the plate-shaped body, in which
the connection portion has a function of transmitting vibration of an exciter to the plate-shaped body from a side opposite to a side where the plate-shaped body is located,
the connection portion includes a spacer and an adhesive portion having a lower hardness than the spacer, and
a thickness of the connection portion is defined by a thickness of the spacer.

[2] The diaphragm according to the above [1], in which the spacer includes a loop portion disposed in a loop shape in a plan view of the diaphragm.

[3] The diaphragm according to the above [2], in which the loop portion is a closed loop, and the adhesive portion is disposed inside the closed loop.

[4] The diaphragm according to the above [2] or [3], in which the spacer further includes an island-shaped portion inside the loop portion, and the island-shaped portion is independent of the loop portion.

[5] The diaphragm according to any one of the above [2] to [4], in which the loop portion has a substantially circular shape.

[6] The diaphragm according to any one of the above [2] to [4], in which the loop portion has a polygonal shape.

[7] The diaphragm according to any one of the above [1] to [6], in which the connection portion has a substantially constant thickness.

[8] The diaphragm according to any one of the above [1] to [6], in which the connection portion has a thickness distribution.

[9] The diaphragm according to any one of the above [1] to [8], in which a Young's modulus E_{S} of the spacer and a Young's modulus E_{A} of the adhesive portion satisfy 1.0×10²≤E_{S}/E_{A}≤1.0×10⁷.

[10] The diaphragm according to any one of the above [1] to [9], in which a Young's modulus E_{A} (Pa) of the adhesive portion satisfies 1.0×10⁵≤E_{A}≤1.0×10¹⁰

[11] The diaphragm according to any one of the above [1] to [10], in which a Young's modulus E_{C} (Pa) of the connection portion satisfies 1.0×10⁶≤E_{C}≤1.0×10¹².

[12] The diaphragm according to any one of the above [1] to [11], in which the spacer is connected to the plate-shaped body via an adhesive layer having a thickness equal to or less than a thickness of the spacer.

[13] The diaphragm according to the above [12], in which the adhesive layer has a Young's modulus at 25° C. of 5.0×10⁸ Pa or less.

[14] The diaphragm according to any one of the above [1] to [13], in which the adhesive portion has a linear expansion coefficient measured under a condition of −40° C. to 90° C. of 1.0×10⁴/° C. or more, and
the adhesive portion has a Young's modulus E_{A} of 5.0×10⁸ Pa or less.

[15] The diaphragm according to any one of the above [1] to [14], in which the connection portion has a shear stress of 0.01 MPa or more.

[16] The diaphragm according to any one of the above [1] to [15], in which the spacer contains at least one selected from the group consisting of a metal, a ceramic, a glass, a wood, a fiber, and a resin.

[17] The diaphragm according to the above [16], in which the spacer contains a resin, and
the resin has a Young's modulus at 25° C. of 1.0×10⁶ Pa or more.

[18] The diaphragm according to any one of the above [1] to [17], in which the connection portion has a function of transmitting vibration of the exciter to the plate-shaped body by being directly connected to the exciter.

[19] The diaphragm according to any one of the above [1] to [17], in which the connection portion has a function of transmitting vibration of the exciter to the plate-shaped body by being connected to the exciter via a vibration transmission portion.

[20] The diaphragm according to the above [19], in which the vibration transmission portion includes a mount portion disposed on a connection portion side and an exciter connection portion disposed on an exciter side.

[21] The diaphragm according to the above [20], in which the mount portion and the exciter connection portion are detachable.

[22] The diaphragm according to any one of the above [1] to [21], in which the plate-shaped body is a glass plate.

[23] A diaphragm with an exciter including:
the diaphragm according to any one of the above [1] to [22]; and
an exciter connected to the connection portion of the diaphragm.

[24] A vehicular diaphragm, including
the diaphragm according to any one of the above [1] to [22] or the diaphragm with an exciter according to the above [23], in which
the diaphragm or the diaphragm with an exciter is used for a vehicle.

[25] The vehicular diaphragm according to the above [24], in which the plate-shaped body of the diaphragm or the diaphragm with an exciter is a vehicular window glass.

[26] The vehicular diaphragm according to the above [25], in which the vehicular window glass is a side glass.

According to the present invention, the thickness of the connection portion of the diaphragm can be controlled by being defined by the spacer. Therefore, an excellent diaphragm with small variations in performance can be provided.

### BRIEF DESCRIPTION OF DRAWINGS

FIG. 1 is a schematic cross-sectional view showing an example of a diaphragm with an exciter according to the present embodiment in which the diaphragm is connected to the exciter.

FIG. 2 is a schematic cross-sectional view showing an example of a positional relationship between a spacer and an adhesive portion when a connection portion is connected to an exciter in a plan view of a diaphragm according to the present embodiment.

FIG. 3 is a schematic cross-sectional view showing an example of a positional relationship between a spacer and an adhesive portion when a connection portion is connected to an exciter in a plan view of a diaphragm according to the present embodiment.

FIG. 4 is a schematic cross-sectional view showing an example of a positional relationship between spacers and an adhesive portion when a connection portion is connected to an exciter in a plan view of the diaphragm according to the present embodiment.

FIG. 5 is a schematic cross-sectional view showing an example of a positional relationship between spacers and an adhesive portion when a connection portion is connected to an exciter in a plan view of a diaphragm according to the present embodiment.

FIG. 6 is a schematic cross-sectional view showing an example of a positional relationship between spacers and an adhesive portion when a connection portion is connected to an exciter in a plan view of a diaphragm according to the present embodiment.

FIG. 7 is a schematic cross-sectional view showing an example of a positional relationship between spacers and an adhesive portion when a connection portion is connected to an exciter in a plan view of a diaphragm according to the present embodiment.

FIG. 8 is a schematic cross-sectional view showing an example of a positional relationship between spacers and an adhesive portion when a connection portion is connected to an exciter in a plan view of a diaphragm according to the present embodiment.

FIG. 9 is a schematic cross-sectional view showing an example of a positional relationship between spacers and an adhesive portion when a connection portion is connected to an exciter in a plan view of a diaphragm according to the present embodiment.

FIG. 10 is a schematic cross-sectional view showing an example of a positional relationship between a spacer and an adhesive portion when a connection portion is connected to an exciter in a plan view of a diaphragm according to the present embodiment.

FIG. 11 is a schematic cross-sectional view showing an example of a diaphragm with an exciter according to the present embodiment in which a diaphragm is connected to the exciter.

FIG. 12 is a schematic cross-sectional view showing an example of a diaphragm with an exciter according to the present embodiment in which the diaphragm is connected to the exciter via a vibration transmission portion.

### DESCRIPTION OF EMBODIMENTS

Hereinafter, the present invention will be described in detail, but the present invention is not limited to the following embodiments, and can be freely modified and implemented without departing from the gist of the present invention. In addition, the symbol “-” or the word “to” that is used to indicate a numerical range includes the numerical values before and after the symbol or the word as the upper limit value and the lower limit value of the range, respectively.

### <Diaphragm>

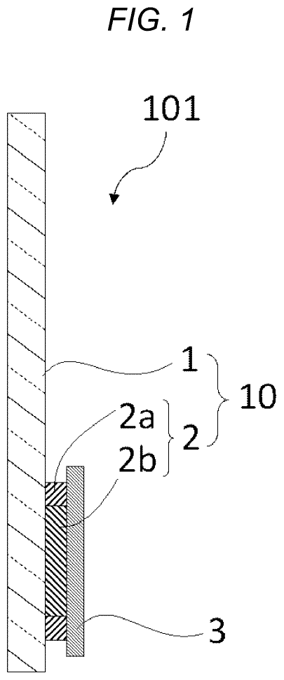

As shown in FIG. 1, a diaphragm 10 according to the present embodiment includes a plate-shaped body 1 having a pair of main surfaces facing each other, and a connection portion 2 connected to one main surface of the plate-shaped body 1. The connection portion 2 is directly connected to the exciter 3, and thus has a function of transmitting vibration of the exciter 3 to the plate-shaped body 1 from a side opposite to a side where the plate-shaped body 1 is located. FIG. 1 shows an example of a diaphragm with an exciter 101 according to the present embodiment in which the diaphragm 10 and the exciter 3 are connected, but as will be described later, the diaphragm may be configured to transmit the vibration of the exciter to the plate-shaped body via a vibration transmission portion between the connection portion and the exciter.

The connection portion 2 includes a spacer 2a and an adhesive portion 2b. The adhesive portion 2b has a lower hardness than the spacer 2a, and the thickness of the connection portion 2 is defined by the thickness of the spacer 2a.

The thickness of the connection portion 2 being defined by the thickness of the spacer 2a means that the thickness of the connection portion 2 is determined by the thickness of the spacer 2a. That is, the thickness of the connection portion 2 may be the same as the thickness of the spacer 2a, but this is not essential.

Examples of the case where the thickness of the connection portion 2 is different from the thickness of the spacer 2a include a case where the thickness of the spacer 2a has a distribution and is not constant and a case where a plurality of spacers 2a having different thicknesses are used. When the spacer 2a is connected to at least one of the plate-shaped body 1 and the exciter 3 via another layer, or when the connection portion 2 is fixed via a curved surface of the plate-shaped body 1 made of a glass or the like having a curvature or a curved surface of the exciter 3 having a curvature, the thickness of the spacer 2a may be different from the thickness of the connection portion 2.

### (Spacer)

The spacer 2a may have a higher hardness than the adhesive portion 2b. Young's modulus can be used as an index of the hardness in the present specification, and if Young's modulus E_{S} of the spacer 2a is higher than Young's modulus E_{A} of the adhesive portion 2b, it can be said that the hardness of the spacer 2a is higher than that of the adhesive portion 2b. The Young's moduli E_{S} and E_{A} are expressed in units of [Pa].

From the viewpoint of easy control of the thickness of the connection portion 2 by the spacer 2a and easy stable holding of the adhesive portion 2b, the spacer 2a preferably includes a loop portion disposed in a loop shape in a plan view of the diaphragm 10. The loop portion is not limited to a closed loop, and may have a loop shape including a notch. The length of the loop shape and the loop shape including the notch, that is, a circumferential length may be freely determined. Further, the width of the loop shape and the loop shape including the notch may be constant or a part thereof may be different from the other portion, but if the width is constant, stabilization can be easily achieved by fixation through the connection portion 2.

The closed loop means an annular shape, that is, a shape surrounding a certain axis over one turn, that is, over 3600 or more, in the plan view of the diaphragm 10, and examples of the closed loop include a substantially circular shape and a polygonal shape. Further, the shape is not limited thereto, and may be a shape in which a substantially circular shape or a polygonal shape is crushed to have a vertex, that is, a protruding portion. In the present specification, the term “substantially circular shape” is a concept including a perfect circle in addition to a substantially circular shape such as a partially deformed circular shape or an elliptical shape. Further, the substantially circular shape may be a shape in which at least a part of the circumference is wavy. Further, in the present specification, the shape of the spacer 2a refers to a shape in the plan view of the diaphragm 10 unless otherwise specified.

The loop shape including the notch means a substantially annular shape in which a part is released in the plan view of the diaphragm 10, and examples thereof include a substantially C shape and a substantially S shape. The loop shape including the notch is a shape having a part of a discontinuous portion with respect to the closed loop shape. The substantially C shape includes a conceptual shape including a U shape, a substantially U shape, a V shape, a substantially V shape, an L shape, and a substantially L shape, in addition to a C shape. The substantially S shape includes a Z shape, a substantially Z shape, a semi-S shape, and a shape including both a linear portion and a curved portion, in addition to an S shape.

Further, the loop portion is not limited to having one notch with respect to the closed loop in one loop portion, and even if there are two or more notches, the loop portion having a substantially annular shape as a whole is included in the loop shape including the notch.

From the viewpoint of controllability of the thickness of the connection portion 2 by the spacer 2a and stable holding performance of the adhesive portion 2b, the loop portion may be a closed loop, and the adhesive portion 2b may be disposed inside the closed loop. In addition to the loop portion, the spacer 2a may further include, inside the loop portion, an island-shaped portion, which will be described later, independent of the loop portion.

Since the loop portion is the closed loop and the adhesive portion 2b is disposed inside the closed loop, in addition to the above, the adhesive portion 2b is less likely to leak from the inside of the spacer 2a. Further, with this arrangement, it is easy to control a filling degree of the adhesive portion 2b into the inside of the closed loop.

In the case where the spacer 2 includes, as a point, a spacer 2a′ that is the island-shaped portion described above in addition to the spacer 2a disposed in the loop shape, the position of the spacer 2a′ that is the island-shaped portion is not particularly limited as long as it is inside the loop portion. The position of the spacer 2a′ that is the island-shaped portion may be, for example, the center of the loop portion or the vicinity thereof in the plan view of the diaphragm 10, or may be an end that is a notch portion in the case where the loop portion has the loop shape having a notch. The number of the spacers 2a′ that are the island-shaped portions is not particularly limited, and may be one or two or more.

A three-dimensional shape of the spacer 2a′ that is the island-shaped portion is not particularly limited, and examples thereof include a cylindrical shape, a polygonal columnar shape, a hollow cylindrical shape, a hollow polygonal columnar shape, and a spherical shape. Further, examples of the three-dimensional shape of the spacer 2a′ that is the island-shaped portion include a three-dimensional pillar shape having a cross shape, an L shape, or an arc shape in the plan view of the diaphragm 10.

The shape of an end portion of the spacer 2a′ that is the island-shaped portion in the thickness direction of the diaphragm 10, that is, a part in direct contact with the exciter 3 or the plate-shaped body 1 or in contact with the exciter 3 or the plate-shaped body 1 via another layer is not particularly limited. Examples of the end portion include a flat plate shape without inclination, a flat plate shape with inclination, a curved surface shape, and a pointed-tip shape.

Further, when there are a plurality of spacers 2a′ that are the island-shaped portions, the shape and size of each island-shaped portion may be the same or different.

Further, in the plan view of the diaphragm 10, by forming the loop portion into the substantially circular shape or the polygonal shape, in addition to the above, a spacer shape optimized in accordance with the shape of the exciter 3 can be obtained.

Although the size of the spacer 2a varies depending on the size of the exciter 3, when a longest diameter of the exciter 3 is, for example, 1 mm to 10 mm in the plan view of the diaphragm 10, the width of the loop-shaped spacer 2a in the plan view of the diaphragm 10 is preferably 1% to 50%, more preferably 2% to 40%, and still more preferably 5% to 30%. Here, the width of the spacer 2a is preferably 1% or more, more preferably 2% or more, and still more preferably 5% or more of the longest diameter of the exciter 3 from the viewpoint of ensuring compressive strength. Further, the width of the spacer 2a is preferably equal to or less than a half of the longest diameter, that is, equal to or less than 50% of the longest diameter, more preferably equal to or less than 40%, and still more preferably equal to or less than 30% from the viewpoint of ensuring adhesive strength of the adhesive portion 2b.

When the longest diameter of the exciter 3 is 10 mm to 100 mm, the width of the loop-shaped spacer 2a in the plan view of the diaphragm 10 is preferably 0.5% to 50%, more preferably 2% to 40%, and still more preferably 5% to 30%. As described above, the width of the spacer 2a is preferably 0.5% or more, more preferably 2% or more, and still more preferably 5% or more of the longest diameter of the exciter 3 from the viewpoint of ensuring the compressive strength. The width of the spacer 2a is preferably 50% or less, more preferably 40% or less, and still more preferably 30% or less of the longest diameter of the exciter 3 from the viewpoint of ensuring the adhesive strength of the adhesive portion 2b.

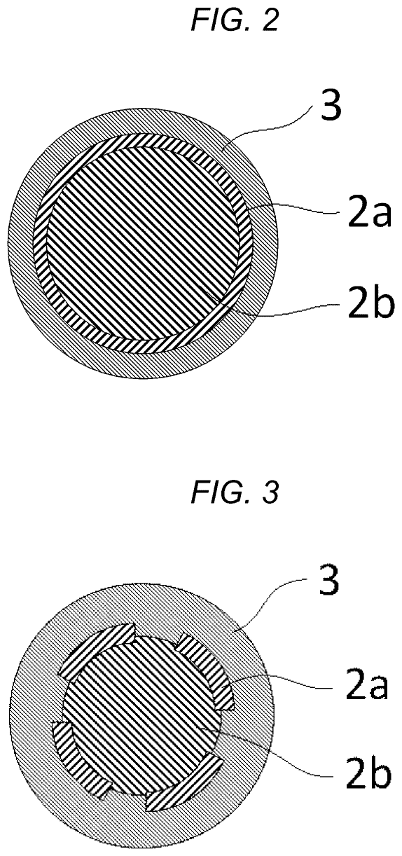

FIGS. 2 to 10 show specific examples in which the spacer 2a forms the loop portion. That is, each of FIGS. 2 to 10 is a schematic cross-sectional view showing an example of a positional relationship between the spacer(s) 2a and the adhesive portion 2b when the connection portion 2 is connected to the exciter 3 in a plan view of the diaphragm 10.

The present embodiment is not limited to the modes shown in FIGS. 2 to 10.

In FIG. 2, the spacer 2a is a circular closed loop, and the adhesive portion 2b is disposed inside the spacer 2a. Since the spacer 2a covers an outer circumference of the adhesive portion 2b, the thickness of the connection portion 2 is more easily controlled. Further, the adhesive portion 2b is stably held without leaking to the outside of the spacer 2a that functions as a weir portion. Further, there is an advantage that the spacer 2a can protect the adhesive portion 2b from water, dust, and the like.

In FIG. 3, the spacer 2a has a loop shape with a substantially circular notch, and the adhesive portion 2b is disposed inside the spacer 2a. Further, the adhesive portion 2b may protrude from the portion where the spacer 2a is not provided. Since the spacer 2a covers an outer circumference of the adhesive portion 2b, the thickness of the connection portion 2 is more easily controlled. The adhesive portion 2b is less likely to leak to the outside of the spacer 2a that functions as a weir portion and is easily stably held, and the amount of the spacer 2a can be reduced. Further, since the spacer 2a has the notch, even when the amount of the material applied as the adhesive portion 2b is equal to or more than a predetermined amount, the adhesive portion 2b protrudes from the notch portion, and thus the thickness of the connection portion 2 is easily defined.

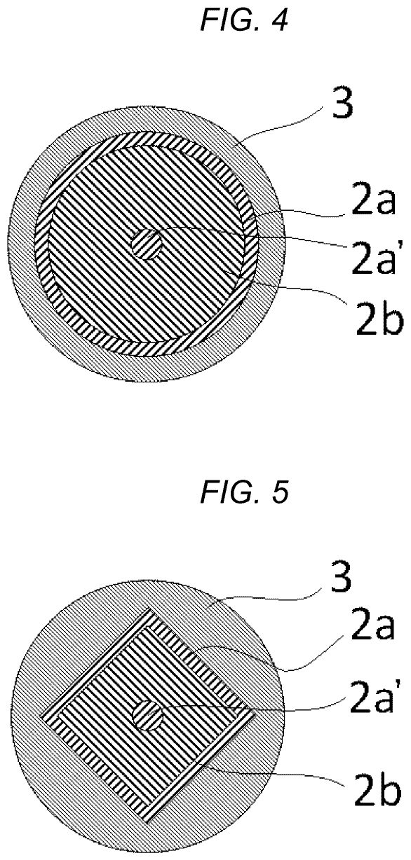

FIG. 4 includes the spacer 2a that is a circular closed loop and the spacer 2a′ that is an island-shaped portion independent of the closed loop inside the spacer 2a. The adhesive portion 2b is disposed inside the closed-loop spacer 2a. In addition to the spacer 2a covering an outer circumference of the adhesive portion 2b, since the spacer 2a′ that is the independent island-shaped portion is present in the central portion, the thickness of the connection portion 2 can be easily controlled. The spacer 2a′ that is the island-shaped portion may be disposed to include the center of gravity of the exciter 3 in the plan view of the diaphragm 10. Further, the adhesive portion 2b is stably held without leaking to the outside of the closed-loop spacer 2a. Further, if an appropriate gap is intentionally provided in the adhesive portion 2b filled in a space formed by the spacer 2a, even when a material having a large cure shrinkage rate is used as the adhesive portion 2b, cracking or the like at the time of shrinkage hardly occurs.

Further, examples of a modification of FIG. 4 include a mode in which the spacer 2a′ that is the island-shaped portion is formed in a hollow cylindrical shape, and the adhesive portion 2b is not included in the central portion of the cylindrical shape, and the like.

FIG. 5 includes the spacer 2a that is a rectangular closed loop, which is a type of the polygonal shapes, and the spacer 2a′ that is the island-shaped portion independent of the closed loop inside the spacer 2a. The adhesive portion 2b is disposed inside the closed-loop spacer 2a. In addition to the spacer 2a covering an outer circumference of the adhesive portion 2b, since the spacer 2a′ that is the independent island-shaped portion is present in the central portion, the thickness of the connection portion 2 can be easily controlled. Further, the adhesive portion 2b is stably held without leaking to the outside of the closed-loop spacer 2a. Further, there is an advantage that the spacer 2a can protect the adhesive portion 2b from water, dust, and the like.

Further, as a modification of FIG. 5, in place of the spacer 2a that is a rectangular closed loop, for example, an example in which the spacer 2a composed of only two facing sides of a rectangular shape as shown in FIG. 10 is used, a mode in which the spacer 2a composed of only two adjacent sides of a rectangular shape is used, a mode in which the spacer 2a composed of three sides of a rectangular shape is used, and the like are exemplified.

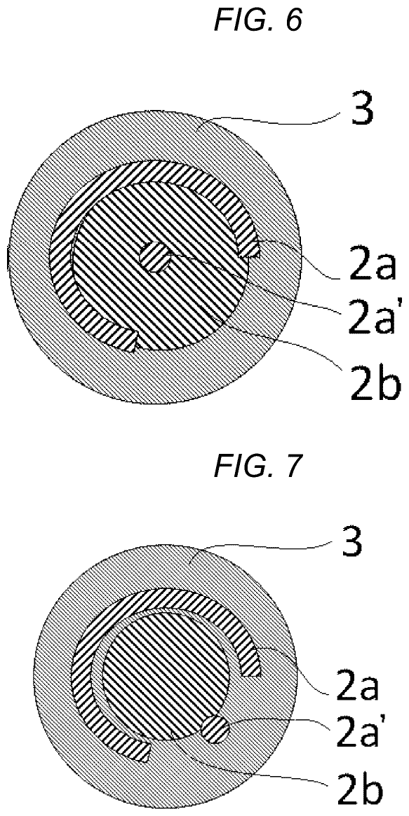

FIG. 6 includes the loop-shaped spacer 2a having a substantially C-shaped notch, and the spacer 2a′ that is the island-shaped portion independent of the loop portion in the vicinity of the center of the loop portion inside the spacer 2a. The adhesive portion 2b is disposed inside the loop-shaped spacer 2a. In addition to the spacer 2a covering a part of the outer circumference of the adhesive portion 2b, the thickness of the connection portion 2 can be easily controlled since the spacer 2a′ that is the independent island-shaped portion is present in the central portion. The adhesive portion 2b is less likely to leak to the outside of the loop-shaped spacer 2a and is easily stably held, and the amount of the spacer 2a can be reduced. The adhesive portion 2b does not necessarily need to be in contact with the spacer 2a, and a gap may be provided between the spacer 2a and the adhesive portion 2b. By intentionally providing an appropriate gap therebetween, even when a material having a large cure shrinkage rate is used as the adhesive portion 2b, cracking or the like at the time of shrinkage hardly occurs.

FIG. 7 includes the loop-shaped spacer 2a having a substantially C-shaped notch, and the spacer 2a′ that is an island-shaped portion independent of the loop-shaped spacer 2a on the inner side of the spacer 2a and at an end that is the notch portion. The adhesive portion 2b is disposed inside the loop-shaped spacer 2a. In addition to the spacer 2a covering a part of an outer circumference of the adhesive portion 2b, the thickness of the connection portion 2 can be easily controlled since the spacer 2a′ that is the independent island-shaped portion is present. The adhesive portion 2b is less likely to leak to the outside of the loop-shaped spacer 2a and is easily stably held, and the amount of the spacer 2a can be reduced.

As shown in FIG. 7, a gap may be provided between the adhesive portion 2b and the spacer 2a. By intentionally providing an appropriate gap therebetween, even when a material having a large cure shrinkage rate is used as the adhesive portion 2b, cracking or the like at the time of shrinkage hardly occurs.

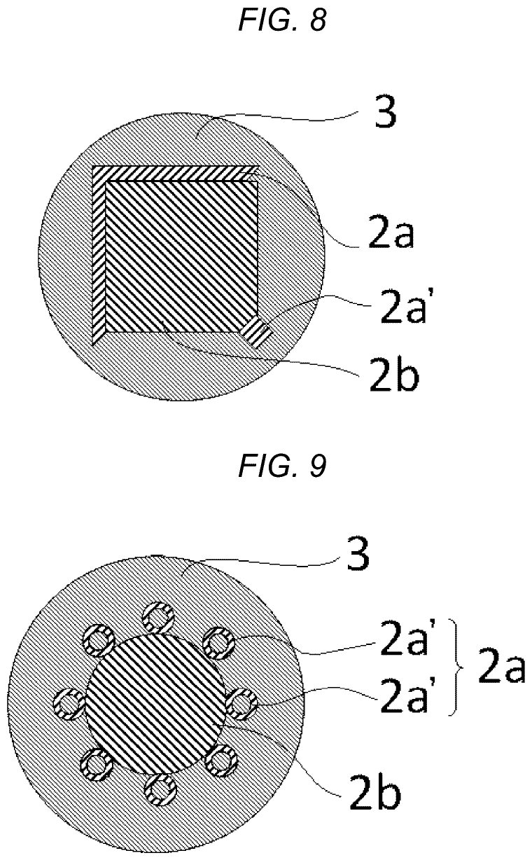

FIG. 8 includes the loop-shaped spacer 2a having a substantially C-shaped such as an L-shaped notch, and the spacer 2a′ that is an island-shaped portion independent of the loop-shaped spacer 2a on the inner side of the spacer 2a and at an end that is the notch portion. The adhesive portion 2b is disposed inside the loop-shaped spacer 2a. In addition to the spacer 2a covering an outer circumference of the adhesive portion 2b, the thickness of the connection portion 2 can be easily controlled since the spacer 2a′ that is the independent island-shaped portion is present. The adhesive portion 2b is less likely to leak to the outside of the loop-shaped spacer 2a and is easily stably held, and the amount of the spacer 2a can be reduced. Further, a gap may be intentionally provided between the adhesive portion 2b and the spacer 2a, and at this time, even when a material having a large cure shrinkage rate is used as the adhesive portion 2b, cracking or the like at the time of shrinkage hardly occurs.

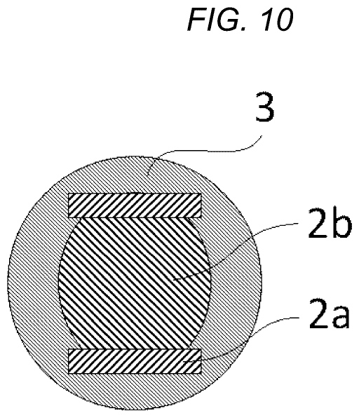

In FIG. 9, the spacers 2a having a substantially circular loop shape with a plurality of notches are constituted by a plurality of spacers 2a′ that are independent island-shaped portions. The adhesive portion 2b is disposed inside the loop-shaped spacers 2a. Since the outer circumference of the adhesive portion 2b is covered with the plurality of spacers 2a, the thickness of the connection portion 2 can be easily controlled. Further, the adhesive portion 2b is less likely to leak to the outside of the spacer 2a and is easily stably held, and the amount of the spacer 2a, that is, the number of the spacers 2a′ that are the island-shaped portions can be reduced.

In this configuration, as the number of the spacers 2a′ that are the island-shaped portions is increased, the loop becomes closer to the closed loop, and the merit of the closed loop is obtained. The number of the spacers 2a′ that are the island-shaped portions is not particularly limited, but the number of the spacers 2a′ that can form a certain loop shape may be disposed. By changing the height of the spacers 2a′ that are the plurality of island-shaped portions, it is easy to make the thickness of the adhesive portion 2b have a distribution.

In addition, the spacer 2a′ (not shown) that is an island-shaped portion disposed inside the loop shape independently of the loop-shaped spacer 2a without forming the loop shape may be separately provided.

Further, in this configuration, in the case where the spacers 2a′ that are the island-shaped portions are hollow, strength against impact is also improved.

In FIG. 10, the spacer 2a has a rectangular loop shape having two notches, and the adhesive portion 2b is disposed inside the spacer 2a. Further, the shape of an outer circumference of the adhesive portion 2b at a portion where the spacer 2a is not provided is not limited to a curved shape as shown in FIG. 10, and can be freely set. The adhesive portion 2b may protrude from the width of the spacer 2a. Since the spacer 2a has a loop shape covering a certain range or more of the outer circumference of the adhesive portion 2b, the thickness of the connection portion 2 is more easily controlled. The adhesive portion 2b is less likely to leak to the outside of the spacer 2a that functions as a weir portion and is easily stably held, and the amount of the spacer 2a can be reduced. Further, since the spacer 2a has the notch, even when the amount of the material applied as the adhesive portion 2b is equal to or more than a predetermined amount, the adhesive portion 2b protrudes from the notch portion, and thus the thickness of the connection portion 2 is easily defined.

In addition, the spacer 2a′ (not shown) that is an island-shaped portion disposed inside the loop shape independently of the loop-shaped spacer 2a without forming the loop shape may be separately provided. Further, the spacers 2a′ that are one or two or more independent island-shaped portions may be provided in the loop-shaped notch portion to form a loop shape closer to the closed loop.

Further, a preferable range of an area S_{S} of the spacer 2a with respect to an area S_{C} of the connection portion 2 in the plan view of the diaphragm 10 is different depending on the hardness of the spacer 2a and an adhesive force of the adhesive portion 2b.

For example, in the case where the spacer 2a is made of metal, the area S_{S} of the spacer 2a when the area S_{C} of the connection portion 2 is 100% is preferably 0.1% to 75%, more preferably 1% to 50%, still more preferably 10% to 30%, and particularly preferably 10% to 20%. Here, the area S_{S} of the spacer 2a is preferably 0.1% or more, more preferably 1% or more, and still more preferably 10% or more from the viewpoint of obtaining a sufficient hardness for the spacer 2a. Although an upper limit is not particularly limited, an effect of the spacer 2a due to an increase in the area S_{S} of the spacer 2a reaches the ceiling. From the viewpoint of increasing the area of the adhesive portion 2b and increasing the adhesive force with the exciter 3, the area S_{S} of the spacer 2a may be 75% or less, and is preferably 50% or less, more preferably 30% or less, and still more preferably 20% or less of the area S_{C} of the connection portion 2.

When a contact area between the exciter 3 and the connection portion 2 is large, the area S_{S} of the spacer 2a is large, and even when the contact area is, for example, about 70%, an absolute area in which the connection portion 2 comes into contact with the exciter 3 increases. Therefore, a good adhesive force is achieved.

As described above, the area S_{S} of the spacer 2a with respect to the area S_{C} of the connection portion 2 may be determined in view of the hardness of the spacer 2a, the adhesive force of the adhesive portion 2b, the contact area between the exciter 3 and the connection portion 2, and the like.

The spacer 2a may have a higher hardness than the adhesive portion 2b, that is, the Young's modulus E_{S} of the spacer 2a may be higher than the Young's modulus E_{A} of the adhesive portion 2b. Accordingly, the thickness of the connection portion 2 can be defined by the thickness of the spacer 2a, and the connection portion 2 having a small film thickness error and a controlled thickness can be achieved. Further, vibration transmissibility is improved since the diaphragm 10 including the connection portion 2 has a high shear stress and the hardness of the connection portion 2 is increased. Meanwhile, it is not necessary to satisfy a high hardness by the adhesive portion 2b alone due to the presence of the spacer 2a. Therefore, it is also possible to suppress cracking of the plate-shaped body 1 due to a difference in the linear expansion coefficients that is generated in the high-hardness adhesive of the related art.

Specifically, the Young's modulus E_{S} of the spacer 2a is preferably 1.0×10⁶ Pa to 1.0×10¹² Pa, more preferably 1.0×10⁷ Pa to 5.0×10¹¹ Pa, and still more preferably 1.0×10⁸ Pa to 1.0×10¹¹ Pa. Here, the Young's modulus E_{S} of the spacer 2a is preferably 1.0×10⁶ Pa or more, more preferably 1.0×10⁷ Pa or more, and still more preferably 1.0×10⁸ Pa or more from the viewpoint of stably defining the thickness of the connection portion 2 as the spacer 2a and from the viewpoint of preventing the transmission of vibration to the plate-shaped body 1 from being inhibited by dissipation of the vibration. From the viewpoint of preventing thermal cracking or the like of the plate-shaped body 1, the Young's modulus E_{S} of the spacer 2a is preferably 1.0×10¹² Pa or less, more preferably 5.0×10¹¹ Pa or less, and still more preferably 1.0×10¹¹ Pa or less.

If a value of the Young's modulus is achieved only by the adhesive portion 2b, a difference in linear expansion coefficients may be too large to cause cracking in the plate-shaped body 1. If this cracking is not caused, the Young's modulus becomes too small, the vibration of the exciter 3 is dissipated, and it becomes difficult to satisfactorily transmit the vibration to the plate-shaped body 1. This is remarkably observed when the plate-shaped body 1 is a glass plate. However, by forming a part of the connection portion 2 with the spacer 2a having the above Young's modulus, the vibration of the exciter 3 can be transmitted to the plate-shaped body 1 without causing cracking in the plate-shaped body 1 and without dissipating the vibration.

The Young's modulus in the present specification is a value measured using an autograph or rheometer based on JIS K 7161: 2014 “Plastics-Determination of tensile properties”.

The spacer 2a is not particularly limited as long as it is made of a material having a hardness higher than that of the adhesive portion 2b, but preferably contains at least one selected from the group consisting of a metal, a ceramic, a glass, a wood, a fiber, and a resin. In addition, a diamond, a mineral, hollow particles, or the like may be used.

When the spacer 2a contains a resin, a Young's modulus of the resin at 25° C. is preferably from 1.0×10⁶ Pa to 1.0×10¹² Pa, more preferably from 1.0×10⁷ Pa to 1.0×10¹² Pa, and still more preferably from 1.0×10⁸ Pa to 1.0×10¹² Pa. Here, a Young's modulus of the resin at 25° C. is preferably 1.0×10⁶ Pa or more, more preferably 1.0×10⁷ Pa or more, and still more preferably 1.0×10⁸ Pa or more from the viewpoint of maintaining a sufficient hardness for the spacer 2a. An upper limit of the Young's modulus is not particularly limited, but is usually 1.0×10¹² Pa or less.

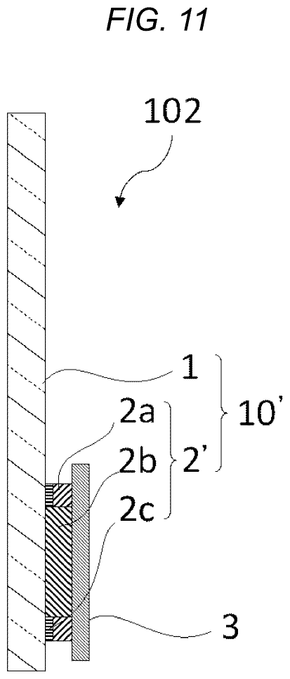

The spacer 2a may be directly connected to the plate-shaped body 1, but a connection portion 2′ may have the adhesive layer 2c connected to the spacer 2a and the spacer 2a may be connected to the plate-shaped body 1 via an adhesive layer 2c, as in a diaphragm 10′ shown in FIG. 11. By interposing the adhesive layer 2c, even when the spacer 2a is made of a material having no adhesion, adhesiveness as the connection portion 2′ is further improved. FIG. 11 shows an example of a diaphragm with an exciter 102 of the present embodiment in which the diaphragm 10′ is connected to the exciter 3.

Similarly, the spacer 2a may be directly connected to the exciter 3, or may be connected to the exciter 3 via the adhesive layer 2c. Further, the adhesive layer 2c may be disposed on both a plate-shaped body 1 side and an exciter 3 side of the spacer 2a, and the spacer 2a may be connected to the plate-shaped body 1 and the exciter 3 via the adhesive layer 2c.

The adhesive layer 2c is a layer that connects the spacer 2a to at least one of the plate-shaped body 1 and the exciter 3 by adhesion or pressure-sensitive adhesion, and may have a single-layer structure constituted by one layer or a multilayer structure constituted by two or more layers.

As the adhesive layer 2c exhibiting adhesiveness, for example, known resin adhesives such as an epoxy-based adhesive, an acrylic-based adhesive, an olefin-based adhesive, a polyimide-based adhesive, a novolac-based adhesive, a silicone-based adhesive, a urethane-based adhesive, a phenol-based adhesive, an epoxy silicone-based adhesive, or a cyanoacrylate-based adhesive can be used. Among them, the acrylic-based adhesive, the silicone-based adhesive, the urethane-based adhesive, and the epoxy silicone-based adhesive are more preferable from the viewpoint of Young's modulus after curing.

As the adhesive layer 2c exhibiting pressure-sensitive adhesiveness, for example, known resin adhesives such as an acrylic-based pressure-sensitive adhesive, a silicone-based pressure-sensitive adhesive, a urethane-based pressure-sensitive adhesive, and an epoxy-based pressure-sensitive adhesive can be used. Among them, the acrylic-based pressure-sensitive adhesive, the silicone-based pressure-sensitive adhesive, and the urethane-based pressure-sensitive adhesive are more preferable from the viewpoint of Young's modulus.

The adhesive layer 2c is not limited to a continuous layer formed by application of the adhesive or the pressure-sensitive adhesive, and may be formed of, for example, a layer in which particles whose surfaces are coated with a component exhibiting adhesiveness or pressure-sensitive adhesiveness are dispersed.

Further, the adhesive layer 2c may be formed by a component exhibiting adhesiveness or pressure-sensitive adhesiveness by an external stimulus such as heat or light.

A Young's modulus of the adhesive layer 2c at 25° C. is preferably 1.0×10⁴ Pa to 5.0×10⁸ Pa, more preferably 1.0×10⁵ Pa to 1.0×10⁸ Pa, and still more preferably 5.0×10⁵ Pa to 5.0×10⁷ Pa. Here, the Young's modulus of the adhesive layer 2c at 25° C. is preferably 5.0×10⁸ Pa or less, more preferably 1.0×10⁸ Pa or less, and still more preferably 5.0×10⁷ Pa or less from the viewpoint of stably forming the adhesive layer 2c between at least one of the plate-shaped body 1 and the exciter 3 and the spacer 2a without the spacer 2a breaking through the adhesive layer 2c. Further, the Young's modulus is preferably 1.0×10⁴ Pa or more, more preferably 1.0×10⁵ Pa or more, and still more preferably 5.0×10⁵ Pa or more from the viewpoint of enhancing adhesion to the at least one of the plate-shaped body 1 and the exciter 3.

The thickness of the adhesive layer 2c is preferably 1% to 100%, more preferably 3% to 50%, and still more preferably 5% to 10% of the thickness of the spacer 2a. Here, the thickness of the adhesive layer 2c is preferably equal to or less than the thickness of the spacer 2a, that is, 100% or less, more preferably 50% or less, and still more preferably 10% or less of the thickness of the spacer 2a from the viewpoint of easily defining the thickness of the connection portion 2 by the spacer 2a. The thickness of the adhesive layer 2c is preferably 1% or more, more preferably 3% or more, and still more preferably 5% or more of the thickness of the spacer 2a from the viewpoint of exhibiting a function as the adhesive layer 2c.

When a total thickness of the spacer 2a and the adhesive layer 2c exceeds 1 mm, the thickness of the adhesive layer 2c is preferably from 0.001 mm to 1 mm, more preferably from 0.01 mm to 0.5 mm, and still more preferably from 0.05 mm to 0.1 mm. Here, the thickness of the adhesive layer 2c is preferably 1 mm or less, more preferably 0.5 mm or less, and still more preferably 0.1 mm or less, and is preferably 0.001 mm or more, more preferably 0.01 mm or more, and still more preferably 0.05 mm or more.

### (Adhesive Portion)

The adhesive portion 2b in the present embodiment is a three-dimensional region having a lower hardness than the spacer 2a and serving to connect the plate-shaped body 1 to the connection portion 2 and the connection portion 2 and to exciter 3.

The material of the adhesive portion 2b is not particularly limited as long as the adhesive portion 2b has adhesiveness or pressure-sensitive adhesiveness to the plate-shaped body 1 or the exciter 3.

When the adhesive portion 2b is made of a resin, a known resin of the related art can be used. Examples thereof include an acrylic-based resin, a cyanoacrylate-based resin, a urethane-based resin, a silicone-based resin, an epoxy-based resin, a polyamide-based resin, a phenol-based resin, a polyester-based resin, a polyether-based resin and the like. Further, a degradable resin such as an electric current peeling or an ultrasonic peeling can also be used.

The method of adhering the resin constituting the adhesive portion 2b is not particularly limited, and may be, for example, any one of a moisture curing type, an ultraviolet curing type, a visible light curing type, a heat curing type, an anaerobic curing type, a hot melt type, a pressure-sensitive adhesive type, and a two-component mixing curing type. Among them, from the viewpoint of reducing damage to an object to be adhered due to heat, adhesion by a moisture curing type, an ultraviolet curing type, a visible light curing type, an anaerobic curing type, a pressure-sensitive adhesive type, or a two-component mixing curing type is preferable.

The Young's modulus E_{A} of the adhesive portion 2b may be lower than the Young's modulus E_{S} of the spacer 2a.

Specifically, a ratio of the Young's modulus represented by E_{S}/E_{A} may be more than 1, preferably more than 1 and 1.0×10⁷ or less, more preferably 1.0×10¹ to 1.0×10⁷, still more preferably 1.0×10² to 1.0×10⁷, and particularly preferably 1.0×10¹ to 1.0×10⁷. Here, the ratio of the Young's modulus is preferably 1.0×10¹ or more, more preferably 1.0×10² or more, and still more preferably 1.0×10³ or more from the viewpoint of vibration transmissibility. An upper limit of the ratio of the Young's modulus represented by E_{S}/E_{A} is not particularly limited, but is usually 1.0×10⁷ or less.

The Young's modulus E_{A} of the adhesive portion 2b is usually 1.0×10⁴ Pa or more, preferably 1.0×10⁴ Pa to 1.0×10¹⁰ Pa, more preferably 1.0×10⁵ Pa to 1.0×10⁹ Pa, still more preferably 3.0×10⁵ Pa to 5.0×10⁸ Pa, particularly preferably 5.0×10⁵ Pa to 1.0×10⁸ Pa, and most preferably 5.0×10⁵ Pa to 1.0×10⁷ Pa. Here, the Young's modulus E_{A} is preferably 1.0×10⁵ Pa or more, more preferably 3.0×10⁵ Pa or more, and still more preferably 5.0×10⁵ Pa or more from the viewpoint of ensuring the shear stress for holding and fixing the exciter 3 to the plate-shaped body 1. When the plate-shaped body 1 is a glass plate, the Young's modulus E_{A} of the adhesive portion 2b is preferably 1.0×10¹⁰ Pa or less, more preferably 1.0×10⁹ Pa or less, still more preferably 5.0×10⁸ Pa or less, particularly preferably 1.0×10⁸ Pa or less, and most preferably 1.0×10⁷ Pa or less from the viewpoint of preventing glass cracking due to a difference in the linear expansion coefficients.

When the linear expansion coefficient of the adhesive portion 2b is small, the adhesive portion 2b cannot withstand the difference in linear expansion coefficients with the plate-shaped body 1 or a housing of the exciter 3, and the glass (plate-shaped body 1) or the housing may be damaged. Therefore, the linear expansion coefficient of the adhesive portion 2b measured under the condition of −40 to 90° C. is preferably 1.0×10⁻⁴/° C. to 1.0/° C., more preferably 5.0×10⁻⁴/° C. to 1.0/° C., and still more preferably 1.0×10⁻³/° C. to 1.0/° C. Here, the linear expansion coefficient is preferably 1.0×10⁻⁴/° C. or more, more preferably 5.0×10⁻⁴/° C. or more, and still more preferably 1.0×10⁻³/° C. or more. An upper limit of the linear expansion coefficient of the adhesive portion 2b is not particularly limited, but is usually 1.0/° C. or less. The linear expansion coefficient in the present specification is a value measured under the condition of −40 to 90° C. in accordance with JIS K 7197: 2012 “Testing method for linear thermal expansion coefficient of plastics by thermomechanical analysis” and JIS R 3102: 1995 “Testing method for average linear thermal expansion of glass”.

At least one of the linear expansion coefficient and the Young's modulus of the adhesive portion 2b preferably satisfies the above range, and more preferably both the linear expansion coefficient and the Young's modulus satisfy the above range.

### (Connection Portion)

The connection portion 2 in the present embodiment is connected to one main surface of the plate-shaped body 1, and has a function of transmitting vibration of the exciter 3 to the plate-shaped body 1 by being connected to the exciter 3. The connection portion 2 includes the spacer 2a and the adhesive portion 2b, but the thickness of the connection portion 2 is defined by the thickness of the spacer 2a.

The connection portion 2 may include the adhesive layer 2c in addition to the spacer 2a and the adhesive portion 2b.

A Young's modulus E_{C} of the entire connection portion 2 is preferably 1.0×10⁶ Pa to 1.0×10¹² Pa, more preferably 5.0×10⁶ Pa to 5.0×10¹¹ Pa, and still more preferably 1.0×10⁷ Pa to 1.0×10¹¹ Pa. Here, the Young's modulus E_{C} is preferably 1.0×10⁶ Pa or more, more preferably 5.0×10⁶ Pa or more, and still more preferably 1.0×10⁷ Pa or more from the viewpoint of vibration transmissibility. The Young's modulus E_{C} of the connection portion 2 is preferably 1.0×10¹² Pa or less, more preferably 5.0×10¹¹ Pa or less, and still more preferably 1.0×10¹¹ Pa or less so that the plate-shaped body 1 and the housing of the exciter 3 are not cracked.

The thickness of the connection portion 2 is defined by the thickness of the spacer 2a, but one main surface of the plate-shaped body 1 and the surface of the exciter 3 connected to the connection portion 2 are parallel to each other, the thickness of the connection portion 2 is also preferably substantially constant. Accordingly, the vibration of the exciter 3 is transmitted to the plate-shaped body 1 without variation, and the performance of the diaphragm 10 is improved.

In order to make the thickness of the connection portion 2 substantially constant, there are a method of making the thickness of the spacer 2a constant, a method of making the thickness of the plurality of spacers 2a′ that are independent island-shaped portions the same, and the like.

In the present specification, the thickness being substantially constant means that a maximum value of a height difference with respect to an average thickness is preferably 10% or less, more preferably 5% or less, and is a concept including a mode in which the maximum value of the height difference is 0%, that is, completely constant (completely the same).

When one main surface of the plate-shaped body 1 and the surface of the exciter 3 connected to the connection portion 2 are not parallel to each other, the thickness of the connection portion 2 preferably has a distribution. More specifically, it is more preferable to connect the plate-shaped body 1 to the exciter 3 in a substantially parallel arrangement by providing the thickness of the connection portion 2 with a distribution. The substantially parallel arrangement is a concept including a parallel arrangement.

Examples of the case where the one main surface of the plate-shaped body 1 and the surface of the exciter 3 are not parallel to each other include a case where at least one of the main surface of the plate-shaped body 1 and the surface of the exciter 3 is a curved surface, a case where at least one of the main surface of the plate-shaped body 1 and the surface of the exciter 3 has unevenness, and a case where at least one of the plate-shaped body 1 and the exciter 3 has an inclination in thickness. In such a case, when the connection portion 2 also has a thickness distribution corresponding to the main surface of the plate-shaped body 1, the plate-shaped body 1 and the exciter 3 can be connected so as to be in the substantially parallel arrangement. Accordingly, the vibration of the exciter 3 can be transmitted to the plate-shaped body 1 without variation.

Further, the connection portion 2 can have a desired thickness distribution by changing the thickness of the spacer 2a or using the spacers 2a′ that are the plurality of island-shaped portions having different thicknesses.

A shear stress of the connection portion 2 varies depending on the size of the exciter 3 to be connected, and is, for example, preferably 0.01 MPa to 30 MPa, more preferably 0.1 MPa to 30 MPa, and still more preferably 1 MPa to 30 MPa. Here, the shear stress is preferably 0.01 MPa or more, more preferably 0.1 MPa or more, and still more preferably 1 MPa or more, from the viewpoint of preventing detachment. An upper limit of the shear stress is not particularly limited, but is usually 30 MPa or less.

The shear stress in the specification is a value measured according to JIS K 6852: 1994 “Testing methods for shear strength of adhesive bonds by compression loading”. Specifically, a value measured by a compression shearing load parallel to an adhesive surface is defined as the shear stress.

### (Plate-Shaped Body)

The plate-shaped body 1 in the present embodiment has the pair of main surfaces facing each other, and one main surface thereof is connected to the connection portion 2. When the connection portion 2 is connected to the exciter 3, the vibration of the exciter 3 is transmitted to the plate-shaped body 1 via the connection portion 2, and functions as the diaphragm 10.

The plate-shaped body 1 is preferably made of a material having a high longitudinal wave sound speed value. The longitudinal wave sound speed value means a velocity at which a vertical wave propagates in an object, and can be measured by an ultrasonic pulse method in accordance with JIS R 1602: 1995. The longitudinal wave sound speed value of the plate-shaped body 1 is, for example, 2000 m/s to 18000 m/s, preferably 3000 m/s to 18000 m/s, more preferably 4000 m/s to 18000 m/s, and still more preferably 5000 m/s to 18000 m/s. Here, the longitudinal wave sound speed value is at least 2000 m/s or more, preferably 3000 m/s or more, more preferably 4000 m/s or more, and still more preferably 5000 m/s or more. An upper limit is not particularly limited, but is usually 18000 m/s or less.

The plate-shaped body 1 may be formed of one plate, or may be formed of a pair of plates, for example, a laminated glass, with an intermediate layer interposed therebetween, from the viewpoint of increasing a loss factor.

When the plate-shaped body 1 is constituted by a pair of plates, a known configuration in the related art can be adopted. For example, at least one of the pair of plates is preferably made of the material having a high longitudinal wave sound speed value. The intermediate layer is preferably, for example, a film layer and a pressure-sensitive adhesive layer from the viewpoint of handleability in a production process, and a semi-solid material layer such as a liquid or a gel from the viewpoint of realizing the high longitudinal wave sound speed value.

Examples of the plate-shaped body 1 include a glass plate, a transparent ceramic, a single crystal such as sapphire, and the like. The glass plate may be an inorganic glass or an organic glass.

The inorganic glass is not particularly limited, and examples thereof include a soda lime glass, an alumino silicate glass, a borosilicate silicate glass, an alkali-free glass, a quartz glass, and the like.

The organic glass is also not particularly limited, and examples thereof include polycarbonate, acrylic resins such as polymethyl methacrylate, and transparent resins such as polyvinyl chloride and polystyrene.

The plate-shaped body 1 is preferably a glass plate in view of transparency and durability, more preferably a glass plate made of an inorganic glass in view of the longitudinal wave sound speed value, and still more preferably a tempered glass subjected to a strengthening treatment. The strengthening treatment may be a chemical strengthening treatment or a physical strengthening treatment.

The glass plate may be a single glass plate or a laminated glass. Examples of the laminated glass include a configuration in which polyvinyl butyral (PVB), ethylene-vinyl acetate copolymer (EVA), polyurethane, or the like having a thickness of 0.3 mm or more and 1.0 mm or less is sandwiched between two glass plates each having a thickness of 1.0 mm or more. In the laminated glass, examples of the layer sandwiched between the two glass plates include a gel layer and a pressure-sensitive adhesive layer in addition to the above. Further, examples of the layer to be sandwiched also include a layer in which the periphery of a liquid layer, a sol layer, a grease layer, or the like is sealed with a pressure-sensitive adhesive, an adhesive, or the like. The thickness of the layer to be sandwiched may be set in the range of, for example, 1 nm or more and 1.0 mm or less.

The plate-shaped body 1 may be a flat plate or a curved plate. For example, when the diaphragm 10 is used for a vehicle, at least one of the main surfaces on the side to which the connection portion 2 is connected may be a curved surface, and the pair of main surfaces may be curved surfaces. The plate-shaped body 1 may have a single-curved shape curved only in a first direction or only in a second direction, or may have a double-curved shape curved in the first direction and the second direction, as for the first direction and the second direction intersecting in a plan view.

### (Diaphragm)

The diaphragm 10 according to the present embodiment includes the plate-shaped body 1 and the connection portion 2. Diaphragms with an exciter 101 and 102 according to the present embodiment include the plate-shaped body 1, the connection portions 2 or 2′, and the exciter 3. Although the exciter 3 is connected to the connection portion of the diaphragm, the diaphragm may be configured to transmit the vibration of the exciter 3 to the plate-shaped body 1 via the vibration transmission portion between the connection portions 2 or 2′ and the exciter 3 as described above.

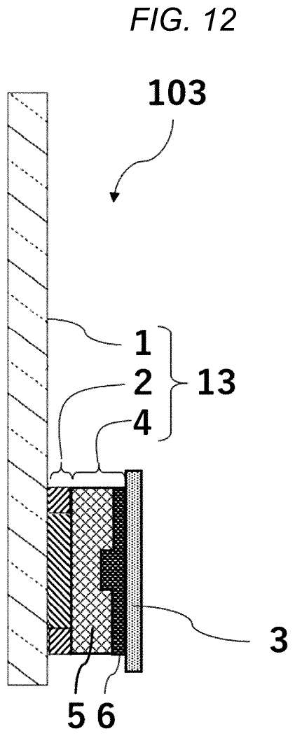

FIG. 12 shows an example of a diaphragm 13 and a diaphragm with an exciter 103 according to the present embodiment, and has the same configuration as the diaphragm 10 and the diaphragm with an exciter 101 except that a vibration transmission portion 4 is disposed between the connection portion 2 and the exciter 3 as compared with the diaphragm 10 and the diaphragm with an exciter 101. The diaphragm 13 includes a vibration transmission portion 4 that connects the connection portion 2 to the exciter 3, and the vibration transmission portion 4 includes, for example, a mount portion 5 on a connection portion 2 side and an exciter connection portion 6 that connects the mount portion 5 to the exciter 3. In the diaphragm 13, the exciter connection portion 6 is not essential, and the mount portion 5 may be directly connected to the exciter 3 or may be connected to the exciter 3 by an adhesive that is not shown.

The mount portion 5 can be formed of a metal material such as aluminum or an aluminum alloy, a titanium alloy, a magnesium alloy, or stainless steel, or a material such as a ceramic, glass, a resin material, a carbon fiber, or a composite material made of these. Examples of the resin material include an acrylic resin such as a polymethyl methacrylate (PMMA) resin, polycarbonate (PC), polyvinyl chloride (PVC), urethane, polypropylene (PP), an acrylonitrile butadiene styrene (ABS) resin, and the like, and can be configured to have an excellent formability. By using the above materials, a sufficient connection strength can be obtained without causing cracking or the like in the mount portion 5.

The exciter connection portion 6 may be firmly fixed to the exciter 3 and a member of the exciter connection portion 6 may be different from that of the exciter 3, or the exciter connection portion 6 and the exciter 3 may be integrated as the same member. The fixing means may be mechanical fastening with screws or the like, or fixing with an adhesive.

In FIG. 12, the connection portion 2 is connected to the mount portion 5 in the diaphragm 13, and the mount portion 5 is connected to the exciter connection portion 6, but the mount portion 5 and the exciter connection portion 6 may be detachably connected to each other. That is, the mount portion 5 and the exciter connection portion 6 may have a structure in which the mount portion 5 and the exciter connection portion 6 can be mechanically fastened to each other by a screw, a rivet, a key, or the like having an uneven cross section. In this case, even when the exciter 3 is replaced due to a failure, the connection portion 2 and the mount portion 5 can be continuously used, and it is only necessary to replace the exciter 3 or the exciter 3 and the exciter connection portion 6.

As the diaphragm 10 and the diaphragms with an exciter 101, 102, and 103, a cover glass for a mobile device that functions as a speaker, a cover glass for a television display that functions as a speaker, a speaker for a display or a wearable display in which a video signal and an audio signal are generated from the same surface, or an interior vibration member of an electric display, a lighting fixture, or a transport device such as a vehicle can be used. Among them, the interior vibration member of the transportation device such as a vehicle is preferable, and a vehicular diaphragm used for a vehicle is more preferable.

Examples of the plate-shaped body 1 in the vehicular diaphragm include a vehicular window glass, an instrument panel, a side mirror, a sun visor, a dashboard, a ceiling, a door, and various other interior panels, and the vehicle window glass is more preferable.

The vehicular window glass that is the plate-shaped body 1 can be used for any one of a windshield, a rear glass, a side glass, and a roof glass, for example, used as a side glass in order to enhance an acoustic effect to an occupant.

As the exciter 3 connected to the diaphragm 10, a known product of the related art can be used. That is, the product includes a coil portion electrically connected to an external device, a magnetic circuit portion, and a vibration application portion connected to the coil portion or the magnetic circuit portion. When an electric signal of sound from the external device is input to the coil portion, the coil portion or the magnetic circuit portion vibrates due to interaction between the coil portion and the magnetic circuit portion. The vibration of the coil portion or the magnetic circuit portion is transmitted to the vibration application portion, and the vibration is transmitted to the plate-shaped body 1 via the connection portion 2 in the present embodiment.

The performance of the vibration body 10 can be verified by an area, thickness, and Young's modulus of the connection portion 2 in a plan view of the plate-shaped body 1. The effect may be verified in a simulated manner from the thickness of the connection portion 2. The thickness of the connection portion 2 can be measured by a caliper or the like, and can be verified from the viewpoint of whether the entire film thickness is uniform.

Whether the thickness of the connection portion 2 is defined by the thickness of the spacer 2a can be determined by whether the thickness of the connection portion 2 is also constant when the thickness of the spacer 2a is constant. When the thickness of the spacer 2a has a distribution, the thickness of the connection portion 2 can be determined from the viewpoint of having a similar distribution or not. In the case of using the plurality of spacers 2a, when the thicknesses of the plurality of spacers 2a are uniform, it can be determined whether the thickness of the connection portion 2 is also uniform. When the plurality of spacers 2a have different thicknesses, it can be determined whether the thickness of the connection portion 2 is defined by the thickness of the spacer 2a from the viewpoint that the thickness of the connection portion 2 also has a distribution corresponding to the thickness of each spacer 2a or not.

A method for manufacturing the diaphragm according to the present embodiment is not particularly limited, and the diaphragm can be manufactured by, for example, a method including the following steps 1 and 2.
Step 1: preparing a plate-shaped body 1 having a pair of main surfaces facing each other; and
Step 2: connecting a connection portion 2 to one main surface of the plate-shaped body 1.

In the step 1, a desired material is selected as the plate-shaped body 1 and can be prepared by a known method of the related art. For example, when the plate-shaped body 1 is a glass plate, the glass plate maybe manufactured or a commercially available one may be used.

In the step 2, the connection portion 2 including a spacer 2a and an adhesive portion 2b is connected to one main surface of the plate-shaped body 1. Examples of the method for connecting the connection portion 2 include a method of applying an adhesive portion 2b after the spacer 2a is installed, a method of applying the adhesive portion 2b and installing the spacer 2a in a gap, and a method of applying the adhesive portion 2b and installing the spacer 2a so as to be embedded in the applied adhesive portion 2b. Among them, a method in which the spacer 2a is installed and then the adhesive portion 2b is applied and a method in which the spacer 2a is installed so as to be embedded in the applied adhesive portion 2b are preferable from the viewpoint of a process property.

When the spacer 2a is installed, it is preferable that the spacer 2a be installed via the adhesive layer 2c. The adhesive layer 2c may be installed on the main surface of the plate-shaped body 1 together with the spacer 2a in a state of being formed on the surface of the spacer 2a in advance, or the spacer 2a may be further installed on the adhesive layer 2c after the adhesive layer 2c is formed on the main surface of the plate-shaped body 1.

As described above, the diaphragm 10 according to the present embodiment is obtained, and before the connection portion 2 is solidified, the exciter 3 or the vibration transmission portion 4 is pressed against the connection portion 2, thereby connecting the diaphragm 10 to the exciter 3 or the vibration transmission portion 4 via the connection portion 2. By connecting the diaphragm 10 to the exciter 3 or the vibration transmission portion 4 via the connection portion 2, the diaphragms with an exciter 101 and 103 according to the present embodiment can be obtained. By connecting the diaphragm 10 to the exciter 3 via the connection portion 2′ having the adhesive layer 2c, the diaphragm with an exciter 102 according to the present embodiment can be obtained.

The diaphragm 10 and the diaphragms with an exciter 101, 102, and 103 according to the present embodiment can transmit the vibration of the exciter 3 to the plate-shaped body 1 without dissipation even when the hardness of the adhesive portion 2b is low, since the spacer 2a can maintain a certain degree of hardness or more. Further, since the hardness of the adhesive portion 2b is low, cracking of the plate-shaped body 1 is suppressed.

### EXAMPLES

Hereinafter, the present invention will be specifically described with reference to test examples, but the present invention is not limited thereto. Examples 1 and 2 are reference inventive examples, Examples 3 and 4 are reference comparative examples, Examples 5 and 6 are inventive examples, and Examples 7 and 8 are comparative examples. In each of the diaphragms 10 of Examples 1 to 4, a glass plate of 20 mm×30 mm×3 mm was used as the plate-shaped body 1, and a polycarbonate plate was used instead of the exciter 3 for evaluation. Therefore, the function of the speaker as the diaphragm 10 is not exhibited, but an adhesive force and the thickness of the connection portion 2 are regarded to be similar to those in the case of using the plate-shaped body 1 that is the speaker. Accordingly, in Examples 1 to 4, it may be considered that the same results as those of inventive examples and comparative examples when the plate-shaped body 1 having a constant size is used to form the diaphragm 10 may be obtained.

### Example 1

The connection portion 2 was formed on a glass plate of 30 mm×20 mm×3 mm by the following method.

The spacer 2a was formed on one main surface of the glass plate. As the spacer 2a, a pair of polycarbonate pieces each having a thickness of 1 mm were prepared, the pair of polycarbonate pieces were fixed in a size of 2 mm×20 mm along a pair of outer peripheries on short-diameter sides of one main surface of the glass plate respectively. In order to connect the spacer 2a to the glass plate, an adhesive tape (adhesive transfer tape F-9460 PC, manufactured by 3M Co., Ltd, thickness: 0.05 mm) was used as the adhesive layer 2c.

Next, the adhesive portion 2b was formed by an acrylic modified silicone-based adhesive (SUPER X No. 8008L Black, manufactured by Cemedine Co., Ltd.) in a region where the spacer 2a was not present on the one main surface of the glass plate by a hand dispenser to obtain a test plate simulating the diaphragm 10.

That is, the spacer 2a has a rectangular loop shape having two notches, and the adhesive portion 2b is disposed inside the spacer 2a. In the plan view of the diaphragm 10, the area S_{C} of the connection portion 2 was 600 mm² with 30 mm×20 mm, the area S_{S} of the spacer 2a was 80 mm² with 20 mm length×2 mm width×2, and S_{S}S_{C}×100≈13.3% at that time.

### Example 2

A test plate was obtained in a similar manner to Example 1 except that the spacer 2a was an aluminum piece having a thickness of 1 mm.

### Example 3

A test plate was obtained in a similar manner to Example 1 except that the spacer 2a was not used, and the adhesive portion 2b was formed only by the acrylic modified silicone-based adhesive (SUPER X No. 8008L Black, manufactured by Cemedine Co., Ltd.) to form the connection portion 2.

### Example 4

A test plate was obtained in the same manner as in Example 1 except that the connection portion 2 was formed only by an epoxy-based adhesive (E-60HP, manufactured by HENKEL CORPORATION) as the adhesive portion 2b without using the spacer 2a.

### (Evaluation: Thickness of Connection Portion 2)

The connection portion 2 of the test plate was connected to the polycarbonate plate instead of the exciter 3 by pressing, and the thickness of the connection portion 2 was measured at three points by a caliper. As a result, it was confirmed that the thickness of the connection portion 2 in Examples 1 and 2 was substantially same as a total thickness of the spacer 2a+the adhesive layer 2c of 1.1 mm, did not have a distribution, and was defined by the thickness of the spacer 2a (a film thickness error was 10% or less). In Examples 3 and 4, it was very difficult to adjust the thickness of the connection portion 2.

The film thickness error of the thickness of the connection portion 2 is shown in Table 1.

### (Evaluation: Young's Modulus)

The Young's modulus E_{S} of the spacer 2a, the Young's modulus E_{A} of the adhesive portion 2b, the Young's modulus E_{C} of the connection portion 2, and the Young's modulus of the adhesive layer 2c were measured by an autograph (AG-X plus, manufactured by Shimadzu Corporation) and a rheometer (MCR 301, manufactured by Anton Paar Japan Corporation). Specifically, the Young's modulus was measured from strain and stress response. The results are shown in Table 1.

### (Evaluation: Linear Expansion Coefficient)

The linear expansion coefficient of the adhesive portion 2b was measured using a thermomechanical analyzer (TMA 7100C, manufactured by Hitachi High-Tech Science Co., Ltd.) in accordance with JIS K 7197: 2012 “Testing method for linear thermal expansion coefficient of plastics by thermomechanical analysis” and JIS R 3102: 1995 “Testing method for average linear thermal expansion of glass”. Specifically, a value measured under a condition of a temperature of −40° C. to 90° C. was defined as the linear expansion coefficient.

The results are shown in Table 1.

### (Evaluation: Shear Stress)

The shear stress of the adhesive portion 2b was measured in accordance with JIS K 6852: 1994. Specifically, peeling was performed by a compression shearing device using an autograph (AG-X plus, manufactured by Shimadzu Corporation), and the measured compression shear strength was defined as the shear stress.

The results are shown in Table 1.

### (Evaluation: Thermal Shock Test)

As a durability evaluation of the plate-shaped body 1, the presence or absence of damage of the plate-shaped body 1 after the test was evaluated in accordance with JIS C 60068-2-14: 2011 “Environmental testing”. Specifically, a cycle of holding at −40° C. for 30 minutes, raising the temperature to 90° C. at 10° C./min, holding at 90° C. for 30 minutes, and lowering the temperature to −40° C. at 10° C./min was defined as one cycle using a thermal shock test apparatus (WINTECH, manufactured by Kusumoto Chemicals, Ltd), and the presence or absence of damage of the plate-shaped body 1 was evaluated after 200 cycles under the condition of a humidity range of 30% to 95%.

The results are shown in Table 1, and “A” means that there was no damage, and “B” means that there was damage. Further, “All damaged” means that all of the three samples subjected to the test were damaged.

TABLE 1

| | | Example 1 | Example 2 | Example 3 | Example 4 |
|---|---|---|---|---|---|
| Adhesive | Component | Acrylic | Acrylic | Acrylic | Epoxy-based |
| portion | | modified | modified | modified | adhesive |
| | | silicone-based | silicone-based | silicone-based | |
| | | adhesive | adhesive | adhesive | |
| | Young's modulus E_{A} | 5.0 × 10⁵ | 5.0 × 10⁵ | 5.0 × 10⁵ | 2.0 × 10⁹ |
| | (Pa) | | | | |
| | Linear expansion | 2.2 × 10⁻⁴ | 2.2 × 10⁻⁴ | 2.2 × 10⁻⁴ | 8.0 × 10⁻⁵ |
| | coefficient/° C. | | | | |
| Spacer | Component | Polycarbonate | Aluminum | None | None |
| | Young's modulus Eₛ | 2.1 × 10⁹ | 6.9 × 10¹⁰ | — | — |
| | (Pa) | | | | |
| Adhesive | Component | Adhesive tape | Adhesive tape | None | None |
| layer | Young's modulus | 5.0 × 10⁵ | 5.0 × 10⁵ | — | — |
| | (Pa) | | | | |

| | | | | |
|---|---|---|---|---|
| Film thickness error (N = 3) | ±10% or less | ±10% or less | ±100% or more | ±100% or more |
| Young's modulus E_{c} (Pa) | 1.2 × 10⁹ | 2.2 × 10⁹ | 5.0 × 10⁵ | 1.5 × 10⁹ |
| E_{S}/E_{A} | 4.2 × 10³ | 1.38 × 10⁵ | — | — |
| Shear stress (MPa) | 1.5 | 1.8 | 1.3 | 13 |
| (in average N = 3) | | | | |
| Thermal shock test −40 | A | A | A | B (All damaged) |
| to 90° C. (N = 3) | | | | |

As described above, by using the adhesive portion 2b having a relatively low hardness, that is, a relatively low Young's modulus and the spacer 2a having a higher hardness than the adhesive portion 2b for the connection portion 2, the thickness of the connection portion 2 can be defined by the thickness of the spacer 2a. As a result, it was confirmed that the connection portion 2 having a small film thickness error and a controlled thickness can be achieved. Further, in the diaphragm according to the present embodiment, the shear stress is not significantly reduced, and the hardness of the connection portion 2 is increased, so that the vibration transmissibility is improved. Meanwhile, since the presence of the spacer 2a eliminates the need for the adhesive portion 2b alone to satisfy a high hardness, it is possible to suppress glass cracking due to a difference in the linear expansion coefficients, which is generated in the high-hardness adhesive of the related art.

### Examples 5 to 8

Next, the diaphragms 10 obtained under the same conditions as those of the reference inventive examples of Examples 1 and 2 and the reference comparative examples of Examples 3 and 4 were evaluated as Examples 5 to 8 in order, except that a laminated glass of 200 mm×300 mm×4.36 mm was used as the plate-shaped body 1 and an exciter was used instead of the polycarbonate plate. The laminated glass was the plate-shaped body 1 in which a PVB film having a thickness of 0.76 mm was sandwiched between a pair of soda lime glasses having a thickness of 1.8 mm as the intermediate layer. Further, as a measurement system, in order to evaluate the vibration transmissibility of the diaphragm with an exciter 102, an acceleration sensor (not shown) was attached to an opposite-side surface of the plate-shaped body 1 from the exciter 3 side in FIG. 11, and a signal obtained by the acceleration sensor when the exciter 3 was vibrated was measured.

In the measurement system, the diaphragm with an exciter 102 of each of Examples 5 to 8 was used, a sine wave of 50 Hz (one cycle: 20 msec) was generated by the exciter 3, and the delay time was measured by the acceleration sensor. The shorter the delay time, the higher the vibration transmissibility, and in Examples 5 to 8, the vibration transmissibility was evaluated to be good if the delay time was within one cycle (20 msec).

As a result, the vibration transmission delay times in Examples 5 to 8 were as follows.

(Example 5) 17.10 msec

(Example 6) 17.08 msec

(Example 7) 21.01 msec

(Example 8) 17.25 msec

From this result, it was confirmed that Examples 5 and 6 exhibited a good vibration transmissibility through the spacer 2a, but Example 7 had a delay time exceeding one cycle (50 msec) and was inferior in the vibration transmissibility. In Example 8, a certain level of vibration transmissibility can be obtained, but as in Example 4 shown in Table 1, the laminated glass which is the plate-shaped body 1 may be damaged by the thermal shock test, and thus a desired weather resistance can not be obtained.

Although the present invention has been described in detail with reference to specific embodiments, it is apparent to those skilled in the art that various changes and modifications can be made without departing from the spirit and scope of the present invention.

### REFERENCE SIGNS LIST

1: plate-shaped body
2 and 2′: connection portion
2a: spacer
2a′: spacer that is island-shaped portion
2b: adhesive portion
2c: adhesive layer
3: exciter
4: vibration transmission portion
5: mount portion
6: exciter connection portion
10 and 10′: diaphragm
101, 102 and 103: diaphragm with exciter

What is claimed is:

1. A diaphragm comprising:
a plate-shaped body having a pair of main surfaces facing each other; and
a connection portion connected to one of the main surfaces of the plate-shaped body, wherein
the connection portion has a function of transmitting vibration of an exciter to the plate-shaped body from a side opposite to a side where the plate-shaped body is located,
the connection portion comprises a spacer and an adhesive portion having a lower hardness than the spacer, and
a thickness of the connection portion is defined by a thickness of the spacer.

2. The diaphragm according to claim 1, wherein the spacer comprises a loop portion disposed in a loop shape in a plan view of the diaphragm.

3. The diaphragm according to claim 2, wherein the loop portion is a closed loop, and the adhesive portion is disposed inside the closed loop.

4. The diaphragm according to claim 2, wherein the spacer further comprises an island-shaped portion inside the loop portion, and
the island-shaped portion is independent of the loop portion.

5. The diaphragm according to claim 1, wherein the connection portion has a substantially constant thickness.

6. The diaphragm according to claim 1, wherein the connection portion has a thickness distribution.

7. The diaphragm according to claim 1, wherein a Young's modulus E_{S} of the spacer and a Young's modulus E_{A} of the adhesive portion satisfy 1.0×10²≤E_{S}/E_{A}≤1.0×10⁷.

8. The diaphragm according to claim 1, wherein the spacer is connected to the plate-shaped body via an adhesive layer having a thickness equal to or less than a thickness of the spacer.

9. The diaphragm according to claim 1, wherein the adhesive portion has a linear expansion coefficient measured under a condition of −40° C. to 90° C. of 1.0×10⁻⁴/° C. or more, and
the adhesive portion has a Young's modulus E_{A} of 5.0×10⁸ Pa or less.

10. The diaphragm according to claim 1, wherein the connection portion has a shear stress of 0.01 MPa or more.

11. The diaphragm according to claim 1, wherein the spacer comprises at least one selected from the group consisting of a metal, a ceramic, a glass, a wood, a fiber, and a resin.

12. The diaphragm according to claim 1, wherein the connection portion has a function of transmitting vibration of the exciter to the plate-shaped body by being directly connected to the exciter.

13. The diaphragm according to claim 1, wherein the connection portion has a function of transmitting vibration of the exciter to the plate-shaped body by being connected to the exciter via a vibration transmission portion.

14. The diaphragm according to claim 13, wherein the vibration transmission portion comprises a mount portion disposed on a connection portion side and an exciter connection portion disposed on an exciter side.

15. The diaphragm according to claim 14, wherein the mount portion and the exciter connection portion are detachable.

16. The diaphragm according to claim 1, wherein the plate-shaped body is a glass plate.

17. A diaphragm with an exciter, comprising:
the diaphragm according to claim 1; and
an exciter connected to the connection portion of the diaphragm.

18. A vehicular diaphragm, comprising:
the diaphragm according to claim 1, wherein
the diaphragm is used for a vehicle.

19. The vehicular diaphragm according to claim 18, wherein the plate-shaped body of the diaphragm is a vehicular window glass.

20. The vehicular diaphragm according to claim 19, wherein the vehicular window glass is a side glass.
